(19) United States
(12) Patent Application Publication
(10) Pub. No.: US 2007/0166439 A1
(43) Pub. Date: Jul. 19, 2007

(54) ENZYMATIC PROCESS FOR ACRYLAMIDE REDUCTION IN FOODSTUFFS

(76) Inventors: Jorn Borch Soe, Tilst (DK); Charlotte Horsmans Poulsen, Brabrand (DK); Thomas Rand, Brondby (DK)

Correspondence Address: FROMMER LAWRENCE & HAUG, 745 FIFTH AVENUE- 10TH FL., NEW YORK, NY, 10151, US

(21) Appl. No.: 11/539,724

(22) Filed: Oct. 9, 2006

Related U.S. Application Data
(63) Continuation-in-part of application No. PCT/IB05/01157, filed on Apr. 7, 2005.

(30) Foreign Application Priority Data
Apr. 7, 2004 (GB) 0407939.8
May 5, 2004 (GB) 0410009.5
Jan. 20, 2005 (GB) 0501198.6

(51) Int. Cl. A23L 1/31

(52) U.S. Cl. 426/281

(57) ABSTRACT

There is provided a process for the prevention and/or reduction of acrylamide formation and/or acrylamide precursor formation in a foodstuff comprising (i) a protein, a peptide or an amino acid and (ii) a first reducing sugar; the process comprising the steps of: (a) contacting the foodstuff with a first enzyme capable of converting the first reducing sugar into a second reducing sugar; and (b) contacting the foodstuff with a second enzyme capable of oxidising a reducing group of the second reducing sugar.

### REFERENCE TO RELATED APPLICATIONS

This application is a continuation-in-part of International Patent Application PCT/IB2005/001157 filed Apr. 7, 2005 and published as WO 2005/096838 on Oct. 20, 2005, which claims priority from Great Britain Patent Application Nos. 0501198.6 filed Jan. 20, 2005, 0410009.5 filed May 5, 2004, and 0407939.8 filed Apr. 7, 2004.

Each of the above referenced applications, and each document cited in this text (“application cited documents”) and each document cited or referenced in each of the application cited documents, and any manufacturer's specifications or instructions for any products mentioned in this text and in any document incorporated into this text, are hereby incorporated herein by reference; and, technology in each of the documents incorporated herein by reference can be used in the practice of this invention.

It is noted that in this disclosure, terms such as “comprises”, “comprised”, “comprising”, “contains”, “containing” and the like can have the meaning attributed to them in U.S. Patent law; e.g., they can mean “includes”, “included”, “including” and the like. Terms such as “consisting essentially of” and “consists essentially of” have the meaning attributed to them in U.S. Patent law, e.g., they allow for the inclusion of additional ingredients or steps that do not detract from the novel or basic characteristics of the invention, i.e., they exclude additional unrecited ingredients or steps that detract from novel or basic characteristics of the invention, and they exclude ingredients or steps of the prior art, such as documents in the art that are cited herein or are incorporated by reference herein, especially as it is a goal of this document to define embodiments that are patentable, e.g., novel, nonobvious, inventive, over the prior art, e.g., over documents cited herein or incorporated by reference herein. And, the terms “consists of” and “consisting of” have the meaning ascribed to them in U.S. Patent law; namely, that these terms are closed ended.

The present invention relates to the control of the formation of acrylamide in a foodstuff.

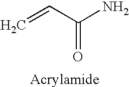

Acrylamide and polyacrylamide are used in industry for the production of plastics. It has been supposed that the main exposure for acrylamide in the general population has been through drinking water and tobacco smoking. Exposure via drinking water is small and the EU has determined maximum levels of 0.1 microgram per litre water.

Acrylamide is water soluble and is quickly absorbed in the digestive tract. Excretion via the urine is fast and half of acrylamide is cleared from the body in a few hours.

The toxicological effects of acrylamide are well known. It causes DNA damage and at high doses neurological and reproductive effects have been observed. Glycidamide, a metabolite of acrylamide, binds to DNA and can cause genetic damage. Prolonged exposure has induced tumours in rats, but cancer in man has not been convincingly shown. The International Agency for Research on Cancer (IARC) has classified acrylamide as “probably carcinogenic to humans” (Group 2A).

It should be noted that the genotoxic studies have indicated that there is no threshold value for the risk of cancer induced by acrylamide, i.e. there is no dose of acrylamide so low that it does not increase the risk of cancer. In making these assessments it is assumed that man and rat have the same sensitivity for cancer induction by acrylamide.

The results of the risk assessments are somewhat different since they are based on different mathematical models. By consumption of 1 microgram acrylamide/kg body weight per day the lifetime risk for cancer has been calculated as
4.5 per 1000 (U.S. EPA)
0.7 per 1000 (WHO)
10 per 1000 (Granath et al. 1999, Stockholm University)

Recent analyses have now indicated that the exposure to acrylamide is probably considerably higher (for non-smokers) from consumption of certain foods that have been heated. As reported in J. Agic. Food Chem. 2002 Aug. 14; 50(17): 4998-5006 a group at the University of Stockholm, headed by Prof. Margareta Törnqvist, has found that acrylamide is formed during heating of starch-rich foods to high temperatures.

When foodstuffs were analysed at the Swedish National Food Administration (NFA) in Uppsala and at AnalyCen AB in Lidköping it was found that some foodstuffs, which had been heated, could contain relatively high levels of the substance acrylamide. In total, more than 100 food samples have been analysed at the NFA. The food survey comprised bread, pasta, rice, fish, sausages, meat (beef and pork), biscuits, cookies, breakfast cereals and beer, etc as well as some ready-made dishes such as pizza and products based on potatoes, maize and flour.

The levels of acrylamide vary considerably between single foodstuffs within food groups, but potato crisps and French fries generally contained high levels compared to many other food groups. The average content in potato crisps is approximately 1000 microgram/kg and in French fries approximately 500 microgram/kg. Other food groups which may contain low as well as high levels of acrylamide are crisp bread, breakfast cereals, fried potato products, biscuits, cookies and snacks, e.g. popcorn.

Foodstuffs which are not fried, deep fried or oven-baked during production or preparation are not considered to contain any appreciable levels of acrylamide. No levels could be detected in any of the raw foodstuffs or foods cooked by boiling investigated so far (potato, rice, pasta, flour and bacon).

A Report from the Swedish Scientific Expert Committee entitled “Acrylamide In Food—Mechanisms of formation and influencing factors during heating of foods” discloses possible mechanisms for the formation of acrylamide in food.

According to Health Canada, model experiments carried out in the Food Directorate showed that when asparagine is heated with glucose, acrylamide is produced. In an open letter, Health Canada stated “The production of acrylamide in these studies was temperature dependent and gave comparable results to those found when potato slices were similarly heated. At this time, not much is known about other possible pathways of formation of acrylamide in foods.”

Further discussion of reactions occurring during heating of food is given in Principles of Food Chemistry pages 100-109.

It is a well known fact that acrylamide has been found in several starch-rich foodstuffs (Becalski, A., Lau, B. P., Lewis, D. & Seaman, S. W., Acrylamide in foods: occurrence, sources, and modeling, J. Agric. Food Chem. 51, 802-808 (2003)). Research has shown that acrylamide production occurs particularly in fried, oven baked and deep fried potatoes and cereal products as a result of high temperature processing (Stadler, R. H., et al. Acrylamide from Maillard reaction products. Nature 419, 449-450 (2002)). Acrylamide was shown to be a side product of the series of reactions and condensations leading to Maillard products (Mottram, D. S., Wedzicha, B. L., & Dodson, A. T., Acrylamide is formed in the Maillard reaction. Nature 419, 448-449 (2002)). The first step of these reactions involves the nucleophilic attack of a free amine group on the carbonyl group of a reducing sugar. It has further been shown that the expulsion of the nitrogen containing compound acrylamide, occurs predominantly when the initial amine group stems from asparagine (Rosen, J. & Hellenas, K. E., Analysis of acrylamide in cooked foods by liquid chromatography tandem mass spectrometry. Analyst 127, 880-882 (2002)).

The formation of acrylamide in foodstuffs, for example in potato chips, has been linked to the combined action of four compounds, namely the amino acid asparagine and the reducing sugars glucose, maltose and fructose (Yaylayan, V. A., Wnorowski, A. & Perez, L. C., Why asparagine needs carbohydrates to generate acrylamide. J. Agric. Food Chem. 51, 1753-1757 (2003)). Deamination of asparagine by asparaginase has proved effective in completely preventing the formation of acrylamide (Zyzak, D. V. et al. Acrylamide formation mechanisms in heated foods. J. Agric. Food Chem. 51, 4782-4787 (2003)). Unfortunately, asparaginase is considered toxic as it is used to treat certain kinds of leukaemia and is therefore unsuitable for treatment of foodstuffs. Any one of the reducing sugars maltose, glucose and fructose in combination with asparagine may lead to acrylamide formation through Maillard reactions. It has been found that removal of any one of these reducing sugars, for example by enzymatic action, reduces the resultant level of acrylamide in a foodstuff such as potato chips.

The present invention alleviates the problems of the prior art.

Some aspects of the invention are defined in the appended claims.

In a first aspect the present invention provides a process for the prevention and/or reduction of acrylamide formation and/or acrylamide precursor formation in a foodstuff comprising (i) a protein, a peptide or an amino acid and (ii) a first reducing sugar; the process comprising the steps of: (a) contacting the foodstuff with a first enzyme capable of converting the first reducing sugar into a second reducing sugar; and (b) contacting the foodstuff with a second enzyme capable of oxidising a reducing group of the second reducing sugar.

In a second aspect the present invention provides use of a first enzyme and a second enzyme for the prevention and/or reduction of acrylamide formation and/or acrylamide precursor formation in a foodstuff comprising (i) a protein, a peptide or an amino acid and (ii) a first reducing sugar, wherein the first enzyme is capable of converting the first reducing sugar into a second reducing sugar; and wherein the second enzyme is capable of oxidising a reducing group of the second reducing sugar.

Acrylamide formation and/or acrylamide precursor formation in cooked foodstuffs, in particular starch foodstuffs and foodstuffs containing a protein/amino acid/peptide and reducing sugar for example by the Amadori reaction, is known in the art. In such foodstuffs a sugar such as glucose, fructose, galactose and/or maltose may react with an amino acid such as asparagine, glutamic acid, lysine, or arginine. Any primary amine capable of nucleophilic attack on the carbonyl group of a reducing sugar may be involved. This reaction may be an important step in the formation of acrylamide.

The present invention prevents and/or reduces the problematic condensation reactions between amino acids, in particular the amino group thereof, and reducing sugars which result in acrylamide or acrylamide precursor formation. These reactions may comprise the Amadori reaction, Heynes rearrangements, or reaction cascades resulting from the Maillard reaction. The present invention may prevent and/or reduce the reaction which directly results in acrylamide formation. It may also prevent and/or reduce reaction(s) which provide materials which further react to provide acrylamide, namely acrylamide precursors. Acrylamide precursors are often provided by degradation of carbohydrates. A typical acrylamide precursor is 2-propenal.

The present applicants have identified that the formation of acrylamide can be controlled by an at least two stage process.

In the first stage of the two stages, a foodstuff comprising a first reducing sugar is contacted with a first enzyme which is capable of converting the first reducing sugar into a second reducing sugar. The first reducing sugar may, for example, be fructose. Fructose can be converted into glucose by the action of the enzyme glucose isomerase which is also known as xylose isomerase (EC 5.3.1.5). In the second stage, the foodstuff is contacted with a second enzyme which is capable of oxidising a reducing group of the second reducing sugar. Thus the first reducing sugar is converted into the second reducing sugar and the second reducing sugar is oxidised thereby eliminating the second reducing sugar from the foodstuff by conversion. In this way, neither the first reducing sugar nor the second reducing sugar is available to take part in acrylamide formation and acrylamide formation and/or acrylamide precursor formation is avoided or reduced.

In one alternative embodiment, a further (third) stage is provided. In the three stage process, an initial foodstuff comprising a non-reducing sugar is contacted with a third enzyme which is capable of converting the non-reducing sugar into a first reducing sugar and/or a second reducing sugar. The non-reducing sugar may, for example, be sucrose which may be converted by the enzymes sucrase or invertase into fructose and glucose. Following this step, the steps of the two stage process are carried out. Thus the non-reducing sugar in converted into a first reducing sugar and/or a second reducing sugar, the first reducing sugar is converted into the second reducing sugar and the second reducing sugar is oxidised thereby eliminating the second reducing sugar from the foodstuff by conversion. As a result of this process, the non-reducing sugar, the first reducing sugar, and the second reducing sugar are all no longer available to take part in acrylamide formation and acrylamide formation and/or acrylamide precursor formation is avoided or reduced.

In the present specification, by the term “prevention and/or reduction of acrylamide formation” it is meant that the amount of acrylamide produced is reduced and/or the period of time required for formation of a given amount of acrylamide is increased.

In some aspects preferably the process prevents and/or reduces the Amadori reaction in a foodstuff.

Thus in one aspect the present invention provides a process for the prevention and/or reduction of the Amadori reaction in a foodstuff comprising (i) a protein, a peptide or an amino acid and (ii) a first reducing sugar; the process comprising the steps of: (a) contacting the foodstuff with a first enzyme capable of converting the first reducing sugar into a second reducing sugar; and (b) contacting the foodstuff with a second enzyme capable of oxidising a reducing group of the second reducing sugar.

In one further aspect the present invention provides use of a first enzyme and a second enzyme for the prevention and/or reduction of the Amadori reaction in a foodstuff comprising (i) a protein, a peptide or an amino acid and (ii) a first reducing sugar; wherein the first enzyme is capable of converting the first reducing sugar into a second reducing sugar and wherein the second enzyme is capable of oxidising a reducing group of the second reducing sugar.

In the present specification, by the term “prevention and/or reduction of the Amadori reaction” it is meant that the extent of the Amadori reaction is reduced and/or the period of time required for completion of the Amadori reaction is increased.

In some aspects, preferably the foodstuff comprises (i) a protein, a peptide or an amino acid; (ii) a first reducing sugar; and (iii) a second reducing sugar.

The term “reducing sugar” as used herein means a carbohydrate that reduces Fehling's (or Benedict's) or Tollens reagent. All monosaccharides whether aldoses or ketoses are reducing sugars. Most disaccharides are reducing sugars; sucrose (common table sugar) is a notable exception, for it is a non-reducing sugar (in: Organic Chemistry by Morrison and Boyd, p 1071, Allyn and Bacon, Inc., third edition (1973)).

By the term “first reducing sugar” it is meant a reducing sugar which is capable of being converted into a “second reducing sugar”, wherein the second reducing sugar comprises a reducing group capable of being oxidised by the second enzyme. In one aspect, the first reducing sugar does not comprise a reducing group capable of being oxidised by the second enzyme. The first reducing sugar and the second reducing sugar are distinct.

As previously mentioned, in one aspect the present invention provides a process for the prevention and/or reduction of acrylamide formation and/or acrylamide precursor formation in a foodstuff comprising (i) a protein, a peptide or an amino acid and (ii) a first reducing sugar; the process comprising the steps of: (a) contacting the foodstuff with a first enzyme capable of converting the first reducing sugar into a second reducing sugar; and (b) contacting the foodstuff with a second enzyme capable of oxidising a reducing group of the second reducing sugar.

In one preferred aspect, preferably the foodstuff comprising (i) a protein, a peptide or an amino acid and (ii) a first reducing sugar, is provided by contacting an initial foodstuff comprising (i) a protein, a peptide or an amino acid and (ii) a non-reducing sugar, with a third enzyme capable of converting the non-reducing sugar into a first reducing sugar and/or a second reducing sugar.

Thus in one aspect, the present invention provides a process for the prevention and/or reduction of acrylamide formation and/or acrylamide precursor formation in a foodstuff comprising (i) a protein, a peptide or an amino acid and (ii) a first reducing sugar; the process comprising the steps of
providing the foodstuff by contacting an initial foodstuff comprising (i) a protein, a peptide or an amino acid and (ii) a non-reducing sugar, with a third enzyme capable of converting the non-reducing sugar into a first reducing sugar and/or a second reducing sugar;
contacting the foodstuff with a first enzyme capable of converting the first reducing sugar into a second reducing sugar; and
contacting the foodstuff with a second enzyme capable of oxidising a reducing group of the second reducing sugar.

As previously mentioned, in one aspect the present invention provides use of a first enzyme and a second enzyme for the prevention and/or reduction of acrylamide formation and/or acrylamide precursor formation in a foodstuff comprising (i) a protein, a peptide or an amino acid and (ii) a first reducing sugar, wherein the first enzyme is capable of converting the first reducing sugar into a second reducing sugar; and wherein the second enzyme is capable of oxidising a reducing group of the second reducing sugar.

In one preferred aspect, preferably the use additionally comprises use of a third enzyme to provide the foodstuff from an initial foodstuff comprising (i) a protein, a peptide or an amino acid and (ii) a non-reducing sugar, wherein the third enzyme is capable of converting the non-reducing sugar into a first reducing sugar and/or a second reducing sugar.

Preferably the third enzyme is capable of converting the non-reducing sugar into a first reducing sugar and a second reducing sugar.

Preferably the non-reducing sugar is sucrose.

Preferably the third enzyme is sucrase (EC 3.2.1.48) or invertase (EC 3.2.1.26).

In one aspect, the third enzyme is sucrase (EC 3.2.1.48).

In one aspect, the third enzyme is invertase (EC 3.2.1.26).

In one aspect, preferably the third enzyme is contacted with the foodstuff during the production of the foodstuff.

In another aspect, preferably the third enzyme is contacted with the foodstuff after production of the foodstuff.

Preferably the third enzyme is sprayed on the foodstuff as a solution or dispersion.

In one aspect, preferably the first reducing sugar is fructose, preferably D-fructose.

In one aspect, preferably the first enzyme is glucose isomerase [also know as xylose isomerase] (EC 5.3.1.5). Sources of glucose isomerase are disclosed in each of U.S. Pat. Nos. 3,625,828, 3,622,463 and Biochim. Biophys. Acta, 151 (1968) 670-680, Purification, Crystallization and Properties of the D-Xylose Isomerase from Lactobacillus brevis.

Glucose isomerase catalyses the reversible isomerisation of D-fructose and D-glucose. Glucose isomerase may be produced by a number of organisms including Actinoplanes missousriensis, Bacillus coagulans, Streptomyces rubiginosus, Streptomyces phaeochromogenes, Arthrobacter sp. and Streptomyces olivaceus. Glucose isomerase is commercially available from a number of sources.

In one aspect, preferably the second reducing sugar is one or more reducing sugars selected from the group consisting of glucose, lactose, galactose, xylose, mannose, cellobiose and maltose.

In one aspect, preferably the second reducing sugar is or comprises glucose, preferably D-glucose.

As previously mentioned, in one aspect the foodstuff comprises (i) a protein, a peptide or an amino acid; (ii) a first reducing sugar; and (iii) a second reducing sugar.

Thus in one aspect the present invention provides a process for the prevention and/or reduction of acrylamide formation and/or acrylamide precursor formation in a foodstuff comprising (i) a protein, a peptide or an amino acid (ii) a first reducing sugar and (iii) a second reducing sugar; the process comprising the steps of: (a) contacting the foodstuff with a first enzyme capable of converting the first reducing sugar into a second reducing sugar; and (b) contacting the foodstuff with a second enzyme capable of oxidising a reducing group of a second reducing sugar.

Similarly, in one aspect the present invention provides use of a first enzyme and a second enzyme for the prevention and/or reduction of acrylamide formation and/or acrylamide precursor formation in a foodstuff comprising (i) a protein, a peptide or an amino acid (ii) a first reducing sugar, and (iii) a second reducing sugar, wherein the first enzyme is capable of converting the first reducing sugar into a second reducing sugar; and wherein the second enzyme is capable of oxidising a reducing group of a second reducing sugar.

In this aspect, the first reducing sugar which is present in the foodstuff initially and the second reducing sugar which is produced by converting the first reducing sugar need not be the same, although they must both comprise a reducing group which is capable of being oxidised by the second enzyme. For example, the first reducing sugar which is present in the foodstuff initially may be maltose whilst the second reducing sugar which is produced by converting the first reducing sugar may be glucose. Both maltose and glucose comprise a reducing group which is capable of being oxidised by hexose oxidase.

In some aspects preferably the second enzyme is capable of oxidising the reducing group of a monosaccharide and the reducing group of a disaccharide.

In some aspects preferably the second enzyme is hexose oxidase (EC1.1.3.5) or glucose oxidase (EC1.1.3.4). In a highly preferred aspect the second enzyme is hexose oxidase. Preferably the HOX is obtained or prepared in accordance with WO 96/40935. Preferably the HOX is DairyHOX™ available from Danisco A/S, Denmark.

In some aspects preferably the second enzyme may oxidise maltodextrins and/or celludextrins. In a preferred aspect the second enzyme is a carbohydrate oxidase which may oxidise maltodextrins and/or celludextrins. Preferably the carbohydrate oxidase is obtained or prepared in accordance with WO 99/31990. In a preferred aspect, the second enzyme is glucooligosaccharide oxidase (Lin et al. 1991 BioChem. BioPhys. Acta., 118, pp 41-47.)

Hexose oxidase (HOX) is a carbohydrate oxidase originally obtained from the red alga Chondrus crispus. As discussed in WO 96/39851 HOX catalyses the reaction between oxygen and carbohydrates such as glucose, galactose, lactose and maltose. Compared with other oxidative enzymes such as glucose oxidase, hexose oxidase not only catalyses the oxidation of monosaccharides but also disaccharides are oxidised. (Biochemica et Biophysica Acta 309 (1973), 11-22).

The reaction of glucose with hexose oxidase is
D-glucose+O₂→δ-D-gluconolactone+H₂O₂

In an aqueous environment the gluconolactone is subsequently hydrolysed to form gluconic acid. 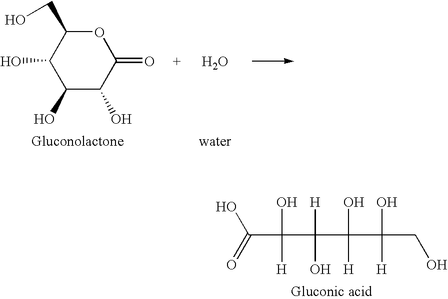
As shown, HOX oxidises the carbohydrate at the reducing end at carbon 1 and thus eliminates the possible involvement of the carbohydrate in acrylamide formation and/or acrylamide precursor formation by Amadori rearrangement or later reaction with a ketoseamine or aldoseamine to a diketoseamine or a diaminosugar respectively.

In a preferred aspect of the present invention the second enzyme is capable of oxidising the second reducing sugar of the foodstuff at the 1 position. This aspect is advantageous because it ensures that the second reducing sugar is oxidised such that the reducing part of the sugar is no longer available to undergo a condensation reaction with an amino acid such as in the Amadori reaction.

In some aspects preferably the foodstuff is selected from bakery goods including bread and cakes, pasta, rice, fish, sausages, meat including beef and pork, biscuits, cookies, crisp bread, cereals, pizza, beverages including coffee, and products based on potatoes, maize and flour, including potato flour and potato starch products.

In some aspects the foodstuff is a beverage.

In some aspects the foodstuff is a starch containing foodstuff.

In some aspects the foodstuff is a cereal or part of a cereal.

In some aspects preferably the foodstuff is selected from a dairy foodstuff; milk based or milk containing foodstuff, such as gratin; an egg based foodstuff; an egg containing foodstuff; bakery foodstuffs including toasts, bread, cakes; and shallow or deep fried foodstuff such as spring rolls.

When the foodstuff is a dairy foodstuff it may be cheese, such as mozzarella cheese.

In some aspects preferably the foodstuff is a potato or a part of a potato. Typical potato products in which the present invention may be applied are potato products in which the potato has been subjected to high temperature processing such as shallow-frying, deep-frying, oven baking and/or oven roasting. The potato may additionally have been processed by other methods such as boiling or poaching. The potato may have been processed whole (peeled or unpeeled) or may have been processed in another form. For example it may have been chopped, diced, sliced, grated, mashed, pureed or converted into potato flour. The potato may have been processed with, for example admixed with, other ingredients such as milk, egg, cheese or butter.

Typical potato products in which the present invention may be applied are French fries, potato chips (crisps), coated French fries and coated potato chips, for example French fries or potato chips coated with corn starch, and potato flour and potato starch products.

Other typical potato products in which the present invention may be applied are products in which the potato is boiled and then fried and/or baked. The potato may typically be chopped, diced, sliced, grated, mashed or pureed prior to being fried and/or baked. This may take place either before or after boiling, but preferably after boiling. In a typical process, the potato is boiled, mashed and then baked, in other words, the product is baked mashed potato. The potato product may be, for example, croquettes, shepherds' pie, cottage pie, gnocchi, rosti or hash browns, preferably croquettes, shepherds' pie or cottage pie.

As previously mentioned, in one aspect the present invention provides a process for the prevention and/or reduction of acrylamide formation and/or acrylamide precursor formation in a foodstuff comprising (i) a protein, a peptide or an amino acid and (ii) a first reducing sugar, the process comprising the steps of: (a) contacting the foodstuff with a first enzyme capable of converting the first reducing sugar into a second reducing sugar; and (b) contacting the foodstuff with a second enzyme capable of oxidising a reducing group of the second reducing sugar.

Step (a) and step (b) of the process may be carried out in any order. In one aspect step (a) is carried out before step (b). In another aspect, step (b) is carried out before step (a). In a further aspect, step (a) and step (b) are carried out substantially simultaneously.

The first enzyme and the second enzyme may be contacted with the foodstuff during its preparation or they may be contacted with the foodstuff after the foodstuff has been prepared yet before the foodstuff is subjected to conditions which may result in the undesirable acrylamide formation and/or acrylamide precursor formation. Alternatively, one of the enzymes may be contacted with foodstuff during its preparation and the other enzyme may be contacted with the foodstuff after the foodstuff has been prepared yet before the foodstuff is subjected to conditions which may result in the undesirable acrylamide formation and/or acrylamide precursor formation.

An enzyme which is contacted with the foodstuff during its preparation will be incorporated in the foodstuff. An enzyme which is contacted with the foodstuff after the foodstuff has been prepared will be present on the surface of the foodstuff. When present on the surface acrylamide formation and/or acrylamide precursor formation is still prevented as it is the surface of a material exposed to drying and atmospheric oxygen which undergoes the predominant acrylamide formation and/or acrylamide precursor formation.

When contacted with foodstuff during its preparation the enzyme or enzymes may be contacted at any suitable stage during its production. In the aspect that the foodstuff is a dairy product the enzyme or enzymes may be contacted with the milk during acidification of the milk and precipitation of the milk curd. In this process the enzyme or enzymes (such as HOX) are not active during the anaerobic conditions created during the acidification and milk protein precipitation, but will be active in the dairy product such as cheese when aerobic conditions are created. For example, once in aerobic conditions the second enzyme may oxidise the second reducing sugar and reduce the tendency to acrylamide formation and/or acrylamide precursor formation.

For application of the enzyme or enzymes to the surface of the foodstuff, one may apply the enzyme or enzymes in any suitable manner.

Typically the enzyme or enzymes are provided in a solution or dispersion and sprayed on the foodstuff. The solution/dispersion may comprise an enzyme in an amount of 1-50 units enzyme/ml. For example, when the second enzyme is to be provided in a solution or dispersion and sprayed on the food and when the second enzyme is hexose oxidase the solution/dispersion may comprise the hexose oxidase in an amount of 1-50 units hexose oxidase/ml.

The enzyme or enzymes may also be added in dry or powder form. When in wet or dry form the enzyme or enzymes may be combined with other components for contact with the foodstuff. For example when the enzyme or enzymes are in dry form they may be combined with an anticaking agent.

It will be appreciated by one skilled in the art that in the practice of the present invention one contacts the foodstuff with a sufficient amount of enzyme or enzymes to prevent and/or reduce a acrylamide formation and/or acrylamide precursor formation.

Typical amounts of the first enzyme which may be contacted with the foodstuff are from 0.005 to 50 U/g (units of the first enzyme per gram of foodstuff), from 0.005 to 10 U/g, from 0.005 to 5 U/g, from 0.005 to 3 U/g, from 0.005 to 2 U/g, from 0.1 to 2 U/g, from 0.1 to 1.5 U/g, and from 0.5 to 1.5 U/g.

Typical amounts of the second enzyme which may be contacted with the foodstuff are from 0.005 to 50 U/g (units of the second enzyme per gram of foodstuff), from 0.005 to 10 U/g, from 0.005 to 5 U/g, from 0.005 to 3 U/g, from 0.005 to 2 U/g, from 0.1 to 2 U/g, from 0.1 to 1.5 U/g, and from 0.5 to 1.5 U/g.

Typical amounts of the third enzyme which may be contacted with the initial foodstuff are from 0.005 to 50 U/g (units of the third enzyme per gram of foodstuff), from 0.005 to 10 U/g, from 0.005 to 5 U/g, from 0.005 to 3 U/g, from 0.005 to 2 U/g, from 0.1 to 2 U/g, from 0.1 to 1.5 U/g, and from 0.5 to 1.5 U/g.

In one preferred aspect the use/process of the present invention further comprises use of a catalase or contacting a catalase with a foodstuff to remove hydrogen peroxide.

In some aspects the foodstuff contains an amino acid. In some aspects the amino acid is asparagine. It has been identified that asparagine is particularly important in the formation of acrylamide in foodstuffs.

In a preferred aspect the enzyme prevents and/or inhibits Amadori reactions and subsequent reactions with asparagine resulting in the formation of acrylamide.

In some aspects the foodstuff contains a protein. In some aspects the foodstuff contains a peptide.

Acrylamide formation and/or acrylamide precursor formation in a foodstuff may take place during the heating thereof or may take place during storage of the foodstuff. For example acrylamide formation and/or acrylamide precursor formation can happen upon storage of any kind of seeds without heating. The second enzyme of the present invention, such as HOX, may still be useful however in removing a second mole of aldose or ketose sugar which may react with the already formed Amadori product to yield the diketoseamine or diaminosugar.

Moreover the system of the present invention may prevent loss of the nutritionally important Lysine in foods.

As a further addition it may be noted that reducing sugars may play an important role in the initiation of Amadori and Maillard reactions at certain moisture levels of the foodstuff (8-12%), but that lipid auto-oxidation, which is also known to initiate Amadori reactions, becomes increasingly common at low moisture levels (6%) (McDonald 1999). Lipid oxidation may actually be the primary cause for the initiation of Amadori or Maillard reactions when reducing sugars are absent. The second enzyme, such as HOX, may serve the dual purpose of removing both the second reducing sugar and oxygen and thereby preventing lipid oxidation as well as sugar hydrolysis at all moisture levels.

In a further aspect the foodstuff is contacted with an asparaginase (EC 3.5.1.1). The foodstuff may be contacted with the asparaginase prior to contact with the first enzyme, subsequent to contact with the first enzyme, simultaneously with the first enzyme or combinations thereof. The foodstuff may be contacted with the asparaginase prior to contact with the second enzyme, subsequent to contact with the second enzyme, simultaneously with the second enzyme or combinations thereof.

Contact with asparaginase may remove asparagine present in the foodstuff. Thus a “two pronged” attack against formation of acrylamide may be provided. On the one hand reducing sugars are removed from the foodstuff by action of the first and second enzyme. On the other hand, asparagine is removed by action of the asparaginase. Thus two of the starting materials for acrylamide forming reactions are eliminated.

The asparaginase may be as described in WO 2004/032648. The asparaginase (EC3.5.1.1) may be derived from Saccharomyces cerevisiae, Candia utilis, Escherichia coli, Aspergillus oryzae, Aspergillus nidulans, Aspergillus fumigatus, Fusarium graminearum, or Penicillium citrinum.

In a highly preferred aspect the present invention provides a process for the prevention and/or reduction of acrylamide formation and/or acrylamide precursor formation in a foodstuff comprising (i) a protein, a peptide or an amino acid and (ii) fructose; the process comprising the steps of: (a) contacting the foodstuff with glucose isomerase; and (b) contacting the foodstuff with hexose oxidase or glucose oxidase, preferably hexose oxidase.

In a further highly preferred aspect the present invention provides a process for the prevention and/or reduction of acrylamide formation and/or acrylamide precursor formation in a foodstuff comprising (i) asparagine and (ii) fructose; the process comprising the steps of: (a) contacting the foodstuff with glucose isomerase; and (b) contacting the foodstuff with hexose oxidase or glucose oxidase, preferably hexose oxidase.

In another highly preferred aspect, the present invention provides a process for the prevention and/or reduction of acrylamide formation and/or acrylamide precursor formation in a foodstuff comprising (i) a protein, a peptide or an amino acid and (ii) fructose; the process comprising the steps of
providing the foodstuff by contacting an initial foodstuff comprising (i) a protein, a peptide or an amino acid and (ii) sucrose, with sucrase or invertase;
contacting the foodstuff with glucose isomerase; and
contacting the foodstuff with hexose oxidase or glucose oxidase, preferably hexose oxidase.

In another highly preferred aspect, the present invention provides a process for the prevention and/or reduction of acrylamide formation and/or acrylamide precursor formation in a foodstuff comprising (i) asparagine and (ii) fructose; the process comprising the steps of
providing the foodstuff by contacting an initial foodstuff comprising (i) asparagine and (ii) sucrose, with sucrase or invertase;
contacting the foodstuff with glucose isomerase; and
contacting the foodstuff with hexose oxidase or glucose oxidase, preferably hexose oxidase.

In one embodiment, the present invention provides a process for the prevention and/or reduction of acrylamide formation and/or acrylamide precursor formation in a foodstuff comprising (i) a protein, a peptide or an amino acid and (ii) a first reducing sugar; the process comprising the steps of
providing the foodstuff by contacting an initial foodstuff comprising (i) a protein, a peptide or an amino acid and (ii) a non-reducing sugar, with a third enzyme capable of converting the non-reducing sugar into a first reducing sugar and a second reducing sugar; and
contacting the foodstuff with a second enzyme capable of oxidising a reducing group of the second reducing sugar.

In a highly preferred aspect of this embodiment, the present invention provides a process for the prevention and/or reduction of acrylamide formation and/or acrylamide precursor formation in a foodstuff comprising (i) asparagine and (ii) fructose and glucose; the process comprising the steps of
providing the foodstuff by contacting an initial foodstuff comprising (i) asparagine and (ii) sucrose, with sucrase or invertase; and
contacting the foodstuff with hexose oxidase or glucose oxidase, preferably hexose oxidase.

In one aspect, preferably the process further comprises the step of heating the foodstuff. In one aspect, preferably the process further comprises the step of heating the foodstuff to a temperature at which acrylamide formation would be expected in the absence of the first and second enzymes. In this aspect, preferably the process further comprises the step of heating the foodstuff to a temperature of at least 80° C., preferably at least 100° C., such as at least 130° C., such as at least 150° C. or at least 200° C. Preferably the heating step is carried out after step (a) and step (b). If step (c) is present (contacting a catalase with the foodstuff), preferably the heating step is carried out after step (a), step (b) and step (c).

In one aspect, preferably the process further comprises the step of baking or frying the foodstuff, preferably frying the foodstuff.

Preferably the foodstuff is a potato or part of a potato. In one aspect preferably the foodstuff is potato chips. In another aspect preferably the foodstuff is baked mashed potato.

In a highly preferred aspect, the present invention provides use of glucose isomerase and hexose oxidase or glucose oxidase, preferably hexose oxidase for the prevention and/or reduction of acrylamide formation and/or acrylamide precursor formation in a foodstuff comprising (i) a protein, a peptide or an amino acid and (ii) fructose.

In a further highly preferred aspect, the present invention provides use of glucose isomerase and hexose oxidase or glucose oxidase, preferably hexose oxidase for the prevention and/or reduction of acrylamide formation and/or acrylamide precursor formation in a foodstuff comprising (i) asparagine and (ii) fructose

In a highly preferred aspect, the present invention provides use of glucose isomerase and hexose oxidase or glucose oxidase, preferably hexose oxidase for the prevention and/or reduction of acrylamide formation and/or acrylamide precursor formation in a foodstuff comprising (i) a protein, a peptide or an amino acid and (ii) fructose and additionally comprises use of sucrase or invertase to provide the foodstuff from an initial foodstuff comprising (i) a protein, a peptide or an amino acid and (ii) sucrose.

In a further highly preferred aspect, the present invention provides use of glucose isomerase and hexose oxidase or glucose oxidase, preferably hexose oxidase for the prevention and/or reduction of acrylamide formation and/or acrylamide precursor formation in a foodstuff comprising (i) asparagine and (ii) fructose and additionally comprises use of sucrase or invertase to provide the foodstuff from an initial foodstuff comprising (i) asparagine and (ii) sucrose.

### FURTHER ASPECTS

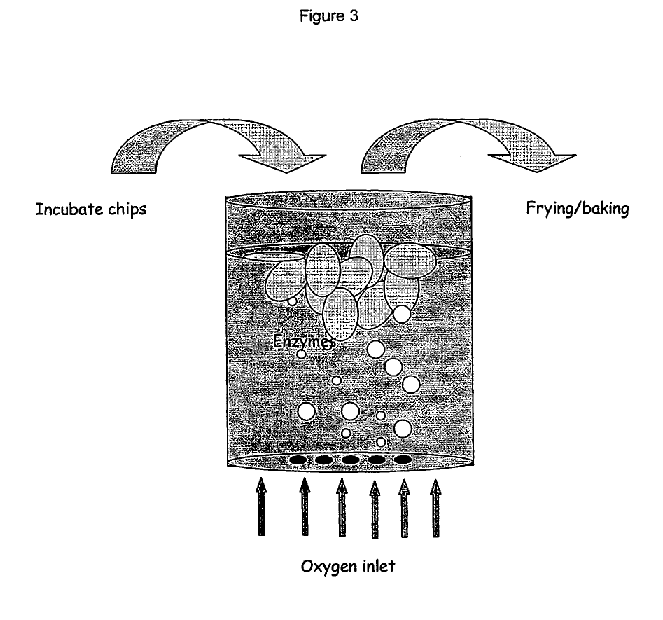

In a further aspect the present invention is practiced in an apparatus shown in FIG. 3. Thus in a further aspect the present invention provides a process for the prevention and/or reduction of acrylamide formation and/or acrylamide precursor formation in a foodstuff comprising (i) a protein, a peptide or an amino acid and (ii) a first reducing sugar; the process comprising the steps of:
(a) contacting the foodstuff with a first enzyme capable of converting the first reducing sugar into a second reducing sugar; and
(b) contacting the foodstuff with a second enzyme capable of oxidising a reducing group of the second reducing sugar,
wherein at least one of the enzymes is in a liquid comprising water and an optional buffer contained in an incubator, wherein oxygen containing gas is introduced into the liquid during the contact of the liquid with the foodstuff.

In one preferred aspect the liquid contain both the first enzyme and the second enzyme. When a third enzyme is present, the liquid may also preferably contain the third enzyme.

We have also found that such a system may be used for achieving contact between any enzyme and foodstuff. Thus in a further aspect the present invention provides a process for contacting a foodstuff with an enzyme; the process comprising the step of: contacting the foodstuff with the enzyme wherein enzyme is in a liquid comprising water and an optional buffer contained in an incubator, wherein oxygen containing gas is introduced into the liquid during the contact of the liquid with the foodstuff.

The present invention will now be described in further detail by way of example only with reference to the accompanying figures in which:

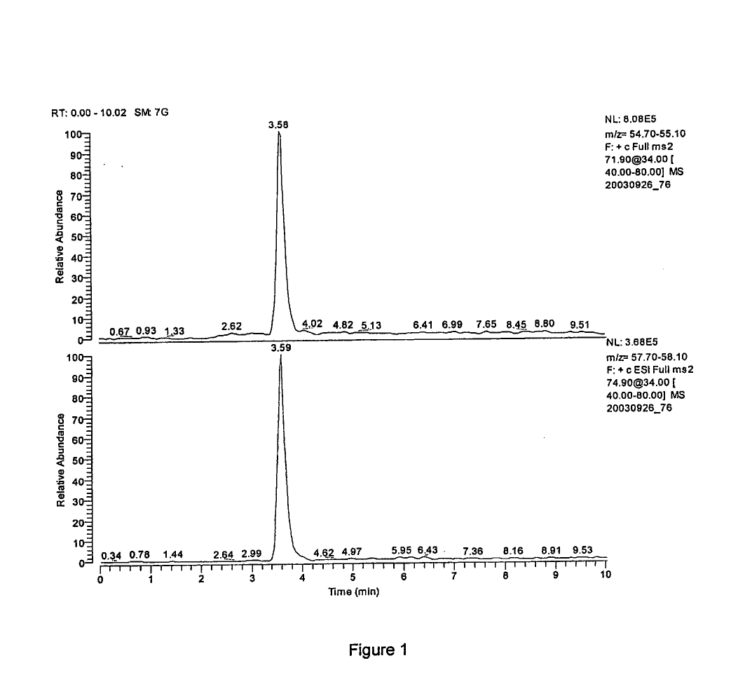

FIG. 1 shows selected reaction monitoring chromatograms (SRM) of an extract of a fried potato.
Upper Selected ion 71.90 (acrylamide), MS2 monitored in the range 40-80 Da
Lower: Selected ion 74.90 ([¹³C₃]acrylamide), MS2 monitored in the range 40-80 Da LC-MS/MS was used with an internal standard (1000 ng/15 ml [¹³C₃]acrylamide) as control to ensure the identity and quantifiability of acrylamide. Analogous daughter ion for the standard (lower) and acrylamide (upper) verifies the identity of the precursor ion. The transitions monitored are m/z 72>m/z 55 (upper, acrylamide) and m/z 75>miz 58 (lower, [¹³C₃]acrylamide).

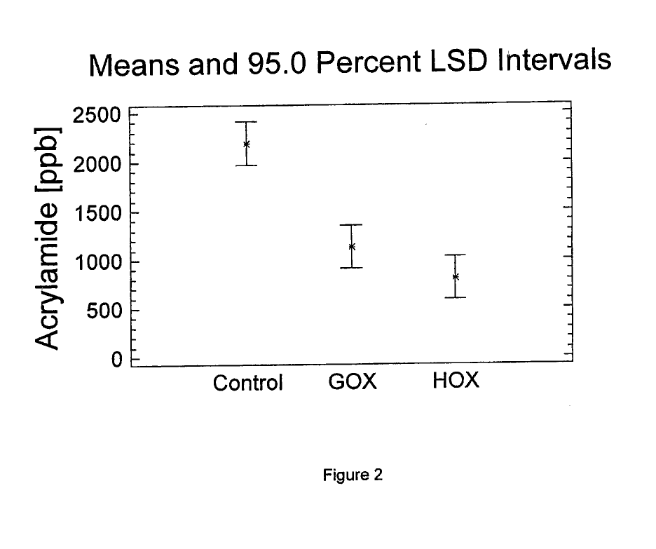

FIG. 2 shows acrylamide measured in mashed and fried potatoes treated with glucose oxidase (GOX) or hexose oxidase (HOX).

FIG. 3 shows apparatus suitable for performing the present invention.

### EXAMPLES

### Example 1

1.1 Hexose Oxidase

A purified hexose oxidase preparation was obtained in accordance with WO01/38544. Alternatively a commercial preparation DairyHOX™ from Danisco A/S, Denmark could be used.

1.2 Determination of Glucose Oxidase and Hexose Oxidase Activity

Definition: 1 glucose oxidase (GOX) unit corresponds to the amount of enzyme which under the specified conditions results in the conversion of 1 μmole glucose per minute, with resultant generation of 1 μmole of hydrogen peroxide (H₂O₂).

Definition: 1 hexose oxidase (HOX) unit corresponds to the amount of enzyme which under the specified conditions results in the conversion of 1 μmole of glucose per minute, with resultant generation of 1 μmole of hydrogen peroxide (H₂O₂).

Assay of GOX and HOX activity in microtiter plates (300 μl)

The commonly used horse radish peroxidase dye substrate ABTS was incorporated into an assay, measuring the production of H₂O₂ produced by HOX or GOX respectively. ABTS serves as a chromogenic substrate for peroxidase. Peroxidase in combination with H₂O₂ facilitates the electron transport from the chromogenic dye, which is oxidised to an intensely green/blue compound.

An assay mixture contained 266 μl β-D-glucose (Sigma P-5504, 0.055 M in 0.1 M sodium phosphate buffer, pH 6.3), 11.6 μl 2,2′-Azino-bis(3-ethylbenzothiozoline-6Sulfonic acid) (ABTS) (Sigma A-9941, 5 mg/ml aqueous solution), 11.6 μl peroxidase (POD) (Sigma P-6782, 0.1 mg/ml in 0.1 M sodium phosphate buffer, pH 6.3) and 10 μl enzyme (HOX or GOX) aqueous solution.

The incubation was started by the addition of glucose at 25° C. The absorbance was monitored at 405 nm in an ELISA reader. A standard curve, based on varying concentrations of H₂O₂, was used for calculation of enzyme activity according to the definition above.

The reaction can be described in the following manner:
β-D-glucose+O₂+H₂O→gluconic acid+H₂O₂ (1)
H₂O₂+2ABTS (colourless)+2H⁺→2H₂O+2ABTS (blue/green) (2)
Reaction (1) is catalysed by enzyme (HOX or GOX)
Reaction (2) is catalysed by enzyme (POD)
   1.3 Determination of Glucose Isomerase Activity

Definition: 1 glucose isomerase (GIM) unit corresponds to the amount of enzyme which under the specified conditions results in the conversion of 1 μmole of D-fructose to 1 μmole D-glucose per minute. The rate of D-glucose generation is measured as described in 1.2.

1.4 Sample Preparation and Quantification by LC-MS/MS

Experimental

Materials

Methanol (Lab Scan, Dublin, Ireland), acetic acid, reagent grade ACS from Scharlau Chemie S.A. (Barcelona Spain).
Oasis MAX (6 cc, 150 mg, Part No. 186000370), Oasis MCX (6 cc, 150 mg, Part No. 186000256) from Waters (Milford, Mass., USA).
Acrylamide-1,2,3-¹³C₃, 1 mg/ml methanol (Product nr. CLM-813-1.2) from Cambridge Isotope Laboratories, Inc. (MA, USA). Acrylamide (Product nr. 14857-1) from Aldrich, (Germany).
   Instrumentals

The HPLC system consisted of a quatemary pump (G1311A), autosampler (G1313A), column compartment (G1316A) all from Agilent Technologies (Waldbronn, Germany). An LCQ Deca Ion Trap mass spectrometer from Thermo Finnigan (San Jose, Calif., USA). Column (Atlantis™ dC₁₈ 3 μm, 2.1 mm id.*150 mm) from Waters (Milford, Mass., USA).

Chromatographic and MS conditions

Mobile phase:

H₂O/MeOH/AcOH (1000/5/1 by volume). The flow rate was 0.20 ml/min.

MS Detector Settings:

Capillary Temp (C): 275
Sheath Gas Flow: 96
Aux Gas Flow: 3
Source Type: ESI
Positive Mode
Source Voltage (kV): 2.00
MSn Micro Scans: 2
MSn Max Ion Time (ms): 500

Scan Event Details:

1: Pos (71.9) > (40.0-80.0)

| | | | | |
|---|---|---|---|---|
| MS/MS: | Amp. 34.0% | Q 0.450 | Time 30.0 | IsoWidth 1.0 |

2: Pos (74.9) > (40.0-80.0)

| | | | | |
|---|---|---|---|---|
| MS/MS: | Amp. 34.0% | Q 0.450 | Time 30.0 | IsoWidth 1.0 |

Standard and Sample Preparation

Calibration standards (acrylamide) were prepared with the following concentrations: 500, 150, 50, 15, 5 ng/ml in water. The concentration of internal standard (acrylamide-1,2,3-¹³C₃) was maintained at 40 ng/ml.

The sample to be analysed was coarsely ground with a knife. An aliquot (1 g) was homogenised (Ultra-Turrax T25) with 15 ml of internal standard, (ISTD, 1000 ng acrylamide 1,2,3-¹³C₃/15 ml H₂O) in a 100 ml beaker. The homogenate was transferred to a 50 ml centrifuge tube and 2 ml of dichloromethane were added. The mixture was shaken and centrifuged at 18000 rev/min (=25000 RCF) in a Sorvall RC-5B centrifuge for 20 min. at 4° C.

An Oasis MAX cartridge and an Oasis MCX cartridge were each conditioned with 5 ml methanol followed by 2*5 ml water. After conditioning, they were combined in series with Oasis MAX on top. An aliquot (1.5 ml) of the supernatant (water) was passed through the Oasis MAX/Oasis MCX tandem (fraction 1). Water (5 ml) was added to the Oasis MAX/Oasis MCX tandem and the eluent was collected in three fractions: Fraction 2 (1 ml), fraction 3 (2 ml) and fraction 4 (2 ml). Fraction 3 was filtered through a 0.45 μm filter (13 mm GHP 0.45 μm Minispike, Waters) and subjected to analysis.

### Example 2. Effect of treatment with GOX and GIM on Mashed Potatoes

Potatoes are peeled and boiled for approximately 1 hour. 1000 g of potatoes are mixed with 400 mL of water and blended (Warring Laboratory Blender Model 32BL79) until no lumps are visible. The homogenous solution is split into 4 equal fractions of approximately 400 g. The fractions are allowed to cool to room temperature. 10 mL reaction solution containing the enzyme combinations of choice, (see below) is added to each of the fractions and mixed gently. All fractions are incubated at (40-60° C.) for 30 minutes. Seven samples of 40 g from each of the fractions are weighed into glass beakers (28 samples total) and microwaved on full power (in a Moulinex® Micro-Chef FM 2515Q, 850 W) in 2+3 minutes increments (total 5 minutes) in blocks of four until all water evaporates and the samples are dry and brown.

The reaction mixtures contained the following:
GOX (500 U)/10 mL
GIM (500 U)/10 mL
GOX, GIM (500 U, 500 U)/10 mL
Control (10 mL water)

The samples are analysed by HPLC/MS as triple injections.

Results show reduction in levels of acrylamide in the samples treated with GOX alone, however even more reduction is achieved in samples treated with GOX/GIM combination

### EXAMPLE 3

Effect of Treatment with HOX and GOX in Fried Mashed Potatoes

Sample Material

Two samples treated with HOX, two samples treated with GOX and two control (untreated) samples.

Methods

Potatoes of the sort “Sava”, were peeled and boiled for app 1 hour. 1000 g of potato tuber was mixed with 400 mL of water and blended (Warring Laboratory Blender Model 32BL79) until no lumps were visible. The homogenous solution was split into 3 equal fractions of approximately 400 g and allowed to cool. 10 mL reaction solution (containing the controls or enzyme of choice, see below) was added to each of the fractions and each of the fractions were blended again separately. All fractions were incubated at room temperature for 60 minutes. Two samples of 40 g were weighed into glass beakers from each of the fractions (6 samples total) and microwaved on full in 5 minutes (750 W) in blocks of three until all water had evaporated and the samples were dry and brown.

The reaction solutions contained the following:
HOX (500 U)/10 mL
GOX (500 U)/10 mL
Control (10 mL water

Results

TABLE 2
Each of six samples are analysed
by HPLC/MS as triple injections.

| Samples | Control | HOX | GOX |
|---|---|---|---|
| 1 | triplicate injections | | |
| 2 | triplicate injections | | |
| 1 | | triplicate injections | |
| 2 | | triplicate injections | |
| 1 | | | triplicate injections |
| 2 | | | triplicate injections |

The results obtained are given below in Table 3 and FIG. 2.

TABLE 3
Least Squares Means for Acrylamide [ppb] with
95% Confidence Intervals

| | | | Standard | Lower | Upper |
|---|---|---|---|---|---|
| Level | Count | Mean | Error | Limit | Limit |
| GRAND MEAN | 18 | 1375.33 | | | |
| Type | | | | | |
| Control | 6 | 2189.33 | 146.61 | 1876.84 | 2501.83 |
| GOX | 6 | 1129.5 | 146.61 | 817.007 | 1441.99 |
| HOX | 6 | 807.167 | 146.61 | 494.673 | 1119.66 |

Conclusion

The effect of using either GOX or HOX to minimise the formation of acrylamide is statistically significant.

### Example 4

Treatment of 10 kg Potato Chips by Enzyme Incubator.

This example relates to treating potato chips before frying in an enzyme incubator containing an oxidoreductase utilizing any of the following sugars as substrate (glucose, maltose, sucrose and fructose) and
(i) Hexose oxidase (EC 1.1.3.5) and/or Glucose oxidase (EC 1.1.3.4), and
(ii) Glucose isomerase (EC 5.3.1.5) and/or Invertase (EC 3.2.1.26)

Catalase (EC 1.11.1.6) may be added in catalytic amounts with the main purpose of regeneration oxygen to a maximum level of the molar solubility in the incubation fluid (and to remove hydrogen peroxide)

Potato chips are immersed in the incubator containing a large body of water and/buffer with enzyme(s). Temperature and pH may be regulated as instrumentally possible. Beneath the incubator is an inlet for air or oxygen. The amount of enzyme and/or incubation time may be determined depending on the ratios oxygen saturation/enzyme amount/potato chip amount/incubator volume. A suitable apparatus is shown in FIG. 3.

Incubation procedure:

100 U of HOX or GOX, 100 U of catalase and 100 U of Glucose isomerase and/or Invertase (commercial products) are added to 1 L of water. The temperature is 25° C. for invertase and 40-60° C. for glucose isomerase. Oxygen flow is set at a minimum of 0.015 L/min through a very fine grating. As vigorous stirring as possible which does not result in damage to the chips is implemented. Portions of 100 g thinly sliced potatoes are incubated for 10 minutes before changing the incubation solution. Alternatively sodium hydroxide or other base is added directly to the incubation solution at a rate to keep the pH at 6 (measured continuously).

The potatoes are subsequently gently flushed with water and fried.

Using catalase combined with oxygen/air bubbling in the incubator allows for the following reduction in acrylamide. Levels of sugars are for white potato, boiled, without skin.

Sugars are listed as the molar percentage left to react following treatment. Molar ratio of sugar:acrylamide is 1:1. Listed is the remaining level of acrylamide following frying as a result of treatment in the enzyme incubator.

| Treatment | fructose | glucose | sucrose | maltose | acrylamide |
|---|---|---|---|---|---|
| None | 21.07 | 30.69 | 36.3 | 12.07 | * |
| GOX | 21.07 | 0 | 36.3 | 12.07 | ** |
| HOX | 21.07 | 0 | 36.3 | 6.04 | ** |
| HOX, | 21.07 | 0 | 18.15 | 6.04 | *** |
| invertase | | | | | |
| GOX, glucose | 21.07 | 0 | 36.3 | 6.04 | *** |
| isomerase | | | | | |
| GOX, glucose | 21.07 | 0 | 03 | 6.04 | **** |
| isomerase, | | | | | |
| invertase | | | | | |

Key
* Poor - high acrylamide level to
**** Good - low acrylamide level

### Example 5

Effect of Treatment with HOX and Invertase on Mashed Potatoes

Potatoes are peeled and boiled for approximately 1 hour. 1000 g of potatoes are mixed with 400 mL of water and blended (Warring Laboratory Blender Model 32BL79) until no lumps are visible. The homogenous solution is split into 4 equal fractions of approximately 400 g. The fractions are allowed to cool to room temperature. 10 mL reaction solution containing the enzyme combinations of choice, (see below) is added to each of the fractions and mixed gently. All fractions are incubated at room temperature for 60 minutes. Seven samples of 40 g from each of the fractions (28 samples total) are weighed into glass beakers and microwaved (in a Moulinex® Micro-Chef FM 2515Q, 850 W) on full power in 2+3 minutes increments (total 5 minutes) in blocks of four until all water evaporates and the samples are dry and brown.

The reaction mixtures contained the following:
HOX (500 U)/10 mL
Invertase (500 U)/10 mL
HOX, Invertase (500 U, 500 U)/10 mL
Control (10 mL water)

The samples are analysed by HPLC/MS as triple injections.

Results show reduction in levels of acrylamide in the samples treated with HOX alone, however, even more reduction is achieved in samples treated with HOX/invertase combination.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. A process for the prevention and/or reduction of acrylamide formation and/or acrylamide precursor formation in a foodstuff comprising (i) a protein, a peptide or an amino acid and (ii) a first reducing sugar; the process comprising the steps of:
(a) contacting the foodstuff with a first enzyme capable of converting the first reducing sugar into a second reducing sugar; and
(b) contacting the foodstuff with a second enzyme capable of oxidising a reducing group of the second reducing sugar.

2. Use of a first enzyme and a second enzyme for the prevention and/or reduction of acrylamide formation and/or acrylamide precursor formation in a foodstuff comprising (i) a protein, a peptide or an amino acid and (ii) a first reducing sugar, wherein the first enzyme is capable of converting the first reducing sugar into a second reducing sugar and wherein the second enzyme is capable of oxidising a reducing group of the second reducing sugar.

3. A process according to paragraph 1 wherein the foodstuff comprising (i) a protein, a peptide or an amino acid and (ii) a first reducing sugar, is provided by contacting an initial foodstuff comprising (i) a protein, a peptide or an amino acid and (ii) a non-reducing sugar, with a third enzyme capable of converting the non-reducing sugar into a first reducing sugar and/or a second reducing sugar.

4. Use according to paragraph 2 additionally comprising the use of a third enzyme to provide the foodstuff from an initial foodstuff comprising (i) a protein, a peptide or an amino acid and (ii) a non-reducing sugar, wherein the third enzyme is capable of converting the non-reducing sugar into a first reducing sugar and/or a second reducing sugar.

5. The invention according to paragraph 3 or 4 wherein the third enzyme is capable of converting the non-reducing sugar into a first reducing sugar and a second reducing sugar.

6. The invention according to paragraph 3, 4 or 5 wherein the non-reducing sugar is sucrose.

7. The invention according to any one of paragraphs 3 to 6 wherein the third enzyme is sucrase (EC 3.2.1.48) or invertase (EC 3.2.1.26).

8. The invention according to any one of paragraphs 3 to 7 wherein the third enzyme is contacted with the foodstuff during the production of the foodstuff.

9. The invention according to any one of paragraphs 3 to 8 wherein the third enzyme is contacted with the foodstuff after production of the foodstuff.

10. The invention according to paragraph 8 or 9 wherein the third enzyme is sprayed on the foodstuff as a solution or dispersion.

11. The invention according to any one of the proceeding paragraphs wherein the foodstuff comprises (i) a protein, a peptide or an amino acid; (ii) a first reducing sugar; and (iii) a second reducing sugar.

12. The invention according to any one of the preceding paragraphs wherein acrylamide formation and/or acrylamide precursor formation is prevented and/or reduced by prevention and/or reduction of the Amadori reaction.

13. The invention according to any one of the preceding paragraphs wherein the first reducing sugar is fructose.

14. The invention according to any one of the preceding paragraphs wherein the first enzyme is glucose isomerase (xylose isomerase EC 5.3.1.5).

15. The invention according to any one of the preceding paragraphs wherein the second reducing sugar is glucose.

16. The invention according to any one of the preceding paragraphs wherein the second enzyme is capable of oxidising the reducing group of a monosaccharide and the reducing group of a disaccharide.

17. The invention according to any one of the preceding paragraphs wherein the second enzyme is capable of oxidising the second reducing sugar at the 1 position.

18. The invention according to any one of the preceding paragraphs wherein the second enzyme is hexose oxidase (EC1.1.3.5).

19. The invention according to any one of the preceding paragraphs wherein the foodstuff is selected from bakery goods including bread, pasta, rice, fish, sausages, meat including beef and pork, biscuits, cookies, cereals, pizza, beverages including coffee, and products based on potatoes, maize and flour, including potato flour and potato starch products.

20. The invention according to any one of the preceding paragraphs wherein the foodstuff is a beverage.

21. The invention according to any one of paragraphs 1 to 19 wherein the foodstuff is a cereal or part of a cereal.

22. The invention according to any one of paragraphs 1 to 19 wherein the foodstuff is a potato or a part of a potato.

23. The invention according to any one of the preceding paragraphs wherein the first enzyme and/or the second enzyme is contacted with the foodstuff during the production of the foodstuff.

24. The invention according to any one of paragraphs 1 to 22 wherein the first enzyme and/or the second enzyme is contacted with the foodstuff after production of the foodstuff.

25. The invention according to paragraph 23 or 24 wherein the first enzyme and/or the second enzyme is sprayed on the foodstuff as a solution or dispersion.

26. The invention according to paragraph 25 wherein the second enzyme is sprayed on the foodstuff as a solution or dispersion, the second enzyme is hexose oxidase and the solution/dispersion comprises the enzyme in an amount of 1-50 units Hexose Oxidase/ml.

27. The invention according to any one of the preceding paragraphs wherein the foodstuff contains an amino acid.

28. The invention according to paragraph 27 wherein the amino acid is asparagine.

29. The invention according to any one of the preceding paragraphs wherein the foodstuff contains a protein.

30. The invention according to any one of the preceding paragraphs wherein the foodstuff contains a peptide.

31. The invention according to any one of the preceding paragraphs further comprising either the step of (c) contacting a catalase with the foodstuff or the use of a catalase for preventing and/or reducing acrylamide formation and/or acrylamide precursor formation.

32. A foodstuff prepared in accordance with the invention of any one of the preceding paragraphs.
